(19) United States
(12) Patent Application Publication
(10) Pub. No.: US 2006/0257534 A1
(43) Pub. Date: Nov. 16, 2006

(54) Bread package for storing bread

(76) Inventor: Kathy Maddock, East Moriches, NY (US)

Correspondence Address: WEISS & WEISS;Suite 251, 300 Old Country Road, Mineola, NY, 11501, US

(21) Appl. No.: 11/403,668

(22) Filed: Apr. 13, 2006

Related U.S. Application Data
(60) Provisional application No. 60/671,368, filed on Apr. 14, 2005.

(51) Int. Cl. A23B 7/148

(52) U.S. Cl. 426/106

(57) ABSTRACT

A package for bread which keeps bread fresh and can be used to store multiple types of bread within a single package.

### RELATED APPLICATIONS

The present application claims priority to provisional application Ser. No. 60/671,368 filed Apr. 14, 2005.

### FIELD OF THE INVENTION

The present invention relates to a package for bread which keeps bread fresh and can be used to store multiple types of bread within a single package.

### BACKGROUND OF THE INVENTION

Within a family, most persons have different tastes in bread. One person may like white bread, while another person may like whole wheat bread, while a further person may like rye bread. Persons choose different types of bread based on taste and diet requirements.

When a person opens a package that contains a food product, such as bread, the bread then can get stale and even moldy. After time, if a person has to buy two or three separate loaves of bread, the last of the bread is not fresh and then gets thrown away.

U.S. Pat. No. 4,709,851 relates to a package for a loaf of bread comprising a flexible, conventional plastic bag which encloses a loaf of bread and a U-shaped support member of card board material within the bag and embracing the loaf of bread. The support member presents a base wall which normally underlies the bottom of the loaf and a pair of opposed end flaps attached to the based wall and extending normally vertically therefrom whereby the support member is generally U-shaped in a configuration to embrace the loaf of bread therewithin.

U.S. Pat. No. 6,637,645 relates to a convertible packaging product which preserves loaf bread. The packaging product includes a foldable paperboard blank having first and second opposing end edges and first and second opposing side edges. The blank is folded along three lateral lines, and is attached along the first and second end edges to define a plurality of joined walls. The three lateral fold lines include a middle fold line and two outer fold lines. First and second spaced apart scores are formed with the blank in a margin adjacent one of the first and second side edges. The first and second scores extend parallel to the side edge and intersect respective outer fold lines. The walls cooperate to form a protective enclosure having a length dimension greater than width dimension, and at least one open end for receiving a loaf of bread.

### SUMMARY OF THE INVENTION

The present invention relates to a packaging that holds multiple types of bread. It is an object of the present invention for the packaging to be made of plastic. It is an object of the present invention for the package to physically separate the different types of bread. It is an object of the present invention for the packaging to allow a user to open one part of the package and remove one type of bread and not expose the rest of the bread to the effects of the environment.

It is an object of the present invention to provide an airtight seal to the package. It is an object of the present invention to provide a zip-lock seal to the package. It is an object of the present invention to provide a separate zip lock seal to each section of the package. It is an object of the present invention to provide a package that is divided in two, wherein the package can be opened by either end, and each section contains a different type of bread.

The present invention relates to a package for storing bread comprising: a package. The package has at least two separate sections, and a divider between the sections. The package has at least two separate mechanisms for opening the package.

### BRIEF DESCRIPTION OF THE DRAWINGS

FIG. 1 is a side view of an embodiment of the present invention.

FIG. 2 is a side view of an embodiment of the present invention.

### DETAILED DESCRIPTION OF THE INVENTION

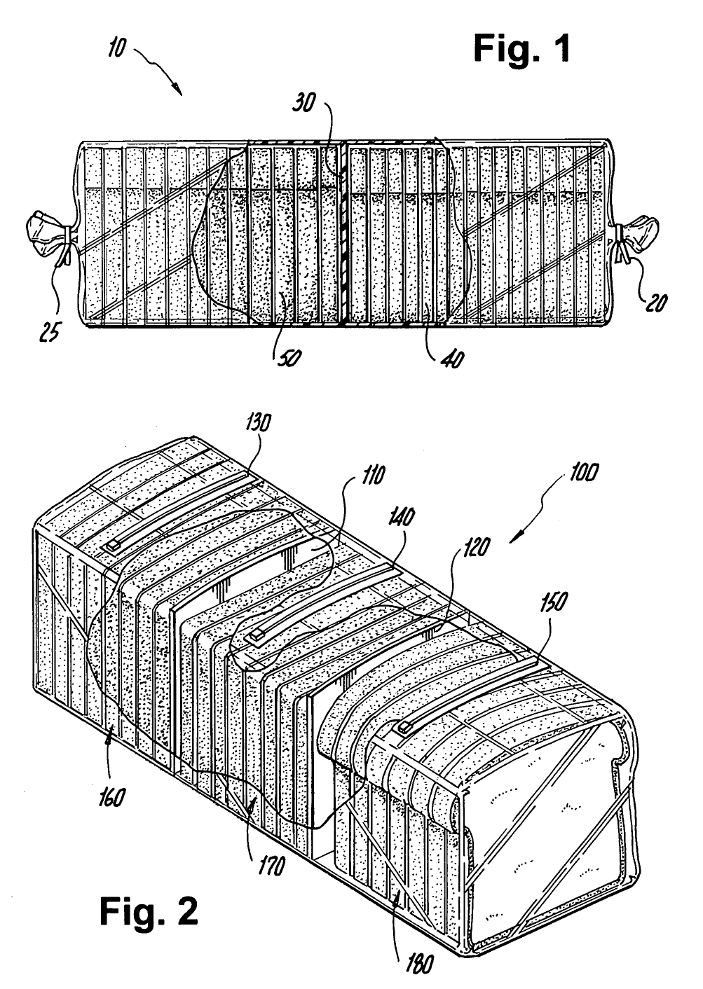

FIG. 1 shows a package 10 having two separate closure mechanisms 20 and 25. The closure mechanisms can be a tie, zip-lock, or other closure mechanism. The package 10 is divided into two sections by a divider 30. In a preferred embodiment the package and the divider are both made of a plastic material. The package contains bread 40 and 50. The bread 40 and 50 can either be the same type of bread or different types of bread.

FIG. 2 shows a package 100. In a preferred embodiment, the package is made of a plastic material. The package 100 is divided into three sections by dividers 110 and 120. It is preferred that the dividers be made of a material that keeps each section airtight. In a preferred embodiment, the dividers 110 and 120 are made of a plastic material.

Package 100 has a zip lock seal 130, 140 and 150. Each zip lock seal mechanism is for a different section of the package. When the zip lock seal 130 is open, only the bread 160 is exposed to the environment. The bread 170 and the bread 180 remain sealed.

1. A package for storing bread comprising:
a package;
said package having at least two separate sections;
a divider between said sections;
at least two separate mechanisms for opening said package.

2. The package of claim 1 wherein said package holds multiple types of bread.

3. The package of claim 1 wherein said package is made of plastic.

4. The package of claim 1 wherein said package allows a user to open one part of said package and remove one type of bread and not expose rest of bread to effects of environment.

5. The package of claim 1 wherein said package further comprises an airtight seal.

6. The package of claim 1 wherein said package further comprises a zip-lock seal.

7. The package of claim 1 wherein each of said sections comprises its own separate zip lock seal.

8. The package of claim 1 wherein said package comprises two separate closure mechanism at each end of said package.

9. The package of claim 8 wherein said closure mechanisms is a tie.

10. The package of claim 8 wherein said closure mechanism is a zip-lock.

11. The package of claim 1 wherein said divider is made of a plastic material.
